(19) United States
(12) Patent Application Publication
(10) Pub. No.: US 2026/0277893 A1
(43) Pub. Date: Sep. 17, 2026

(54) METHOD OF GENERATING QUERY DATA BASED ON INTELLIGENCE AGENTS, ELECTRONIC DEVICE AND STORAGE MEDIUM

(71) Applicant: Beijing Baidu Netcom Science Technology Co., Ltd., Beijing (CN)

(72) Inventors: Jianying QU, Beijing (CN); Jing YAN, Beijing (CN); Xueying LV, Beijing (CN); Jun ZHANG, Beijing (CN)

(21) Appl. No.: 19/684,543

(22) Filed: May 21, 2026

(30) Foreign Application Priority Data
Mar. 16, 2026 (CN) 202610322280.0

(51) Int. Cl. G06F 16/2453; G06F 16/2455

(52) U.S. Cl. CPC G06F 16/24534; G06F 16/2455

(57) ABSTRACT

Provided is a method of generating query data based on intelligence agents, an electronic device and a storage medium, relating to technical fields of dataset construction, query rewriting, query difficulty assessment, query difficulty control and the like. The method includes: inputting initial query data and a target query result into a query-augmented intelligence agent to obtain rewritten current query data; inputting the current query data and the target query result into a query-validated intelligence agent for one or more verifications, to obtain an enhanced query result undergoing the one or more verifications and solving process information; inputting the enhanced query result undergoing the one or more verifications and the solving process information into an analysis-feedback intelligence agent to obtain difficulty feedback information; and outputting query data that meets a difficulty requirement, in a case where the difficulty feedback information indicates that the current query data meets the difficulty requirement.

### CROSS-REFERENCE TO RELATED APPLICATIONS

The present application claims priority to Chinese Patent Application No. CN202610322280.0, filed with the China National Intellectual Property Administration on Mar. 6, 2026, the disclosure of which is hereby incorporated herein by reference in its entirety.

### TECHNICAL FIELD

The present disclosure relates to the field of computer technology, specifically to technical fields of dataset construction, query rewriting, query difficulty assessment, query difficulty control and the like.

### BACKGROUND

In information processing systems such as intelligent question answering, information retrieval, knowledge discovery and the like, to enhance abilities of handling complex queries of the systems, it is often necessary to construct a large amount of query question data with varying levels of difficulty, clear answers, and stable qualities, which is used for application scenarios such as system capability optimization, training sample expansion, functional verification and the like. In a process of constructing the query question data, it is difficult to control difficulty of questions and generation efficiency is low.

### SUMMARY

The present disclosure provides method and apparatus of generating query data based on intelligence agents, and a storage medium.

According to an aspect of the present disclosure, a method of generating query data based on intelligence agents is provided, which includes:
inputting initial query data and a target query result into a query-augmented intelligence agent to obtain rewritten current query data;
inputting the current query data and the target query result into a query-validated intelligence agent for one or more verifications, to obtain an enhanced query result undergoing the one or more verifications and solving process information;
inputting the enhanced query result undergoing the one or more verifications and the solving process information into an analysis-feedback intelligence agent to obtain difficulty feedback information; and
outputting query data that meets a difficulty requirement, in a case where the difficulty feedback information indicates that the current query data meets the difficulty requirement.

According to another aspect of the present disclosure, an apparatus of generating query data based on intelligence agents is provided, which includes:
a query-augmented module configured to input initial query data and a target query result into a query-augmented intelligence agent to obtain rewritten current query data;
a query-validated module configured to input the current query data and the target query result into a query-validated intelligence agent for one or more verifications, to obtain an enhanced query result undergoing the one or more verifications and solving process information;
an analysis-feedback module configured to input the enhanced query result undergoing the one or more verifications and the solving process information into an analysis-feedback intelligence agent to obtain difficulty feedback information; and
an output module configured to output query data that meets a difficulty requirement, in a case where the difficulty feedback information indicates that the current query data meets the difficulty requirement.

According to another aspect of the present disclosure, an electronic device is provided, which includes:
at least one processor; and
a memory connected in communication with the at least one processor;
the memory stores an instruction executable by the at least one processor, and the instruction, when executed by the at least one processor, enables the at least one processor to execute the method of any embodiment in the present disclosure.

According to another aspect of the present disclosure, a non-transitory computer-readable storage medium storing a computer instruction thereon is provided, where the computer instruction is used to cause a computer to execute the method of any embodiment in the present disclosure.

According to another aspect of the present disclosure, a computer program product is provided, which includes a computer program, the computer program, when executed by a processor, implements the method of any embodiment in the present disclosure.

It should be understood that contents described in this part is not intended to identify key or important features of embodiments of the present disclosure, nor is it intended to limit the scope of the present disclosure. Other features of the present disclosure are made easy to be understood by the following description.

### BRIEF DESCRIPTION OF THE DRAWINGS

Accompanying drawings are provided for a better understanding of the present scheme and do not constitute a limitation of the present disclosure, in which:

FIG. 1 is a schematic flow diagram of a method of generating query data based on intelligence agents according to an embodiment of the present disclosure;

FIG. 2 is a schematic flow diagram of a method of generating query data based on intelligence agents according to another embodiment of the present disclosure;

FIG. 3 is a schematic flow diagram of a method of generating query data based on intelligence agents according to another embodiment of the present disclosure;

FIG. 4 is an example of a diagnostic analysis process based on a solving trajectory according to an embodiment of the present disclosure;

FIG. 5 is a structural diagram of multi-intelligent-agent query data acquisition system according to an embodiment of the present disclosure;

FIG. 6 is a structural diagram of an apparatus of generating query data based on intelligence agents according to an embodiment of the present disclosure;

FIG. 7 is a structural diagram of an apparatus of generating query data based on intelligence agents according to another embodiment of the present disclosure;

FIG. 8 is a block diagram of an electronic device for achieving a method according to an embodiment of the present disclosure.

### DETAILED DESCRIPTION

Hereinafter, explanation of exemplary embodiments of the present disclosure will be made in conjunction with the accompanying drawings, which includes various details of the embodiments of the present disclosure to facilitate understanding and should be considered merely exemplary. Therefore, those having ordinary skill in the art should recognize that various changes and modifications may be made to the embodiments described herein without departing from the scope of the present disclosure. Similarly, for clarity and conciseness, descriptions of well-known functions and structures are omitted in the following descriptions.

During a process of constructing data of query questions, there exists an issue of difficulty in uniformly controlling difficulty levels of the query questions. Due to lack of effective means for difficulty assessment and adjustment, generated query question data tends to be concentrated in either an overly easy range or an overly difficult range, making it difficult to form a reasonable difficulty gradient. Meanwhile, relying on human experience to construct complex query questions is not only inefficient but also costly in construction, making it difficult to support sustained, large-scale data generation requirements. For automatically generated or rewritten query question data, there is often a lack of quantitative assessment and feedback mechanisms for the difficulty levels of the query questions, making it difficult to determine whether generated results meet expectations. Furthermore, during a rewriting process of the query questions, semantic drift is easily introduced, which leads to changes in answers corresponding to the query questions, affecting reliability and consistency of data.

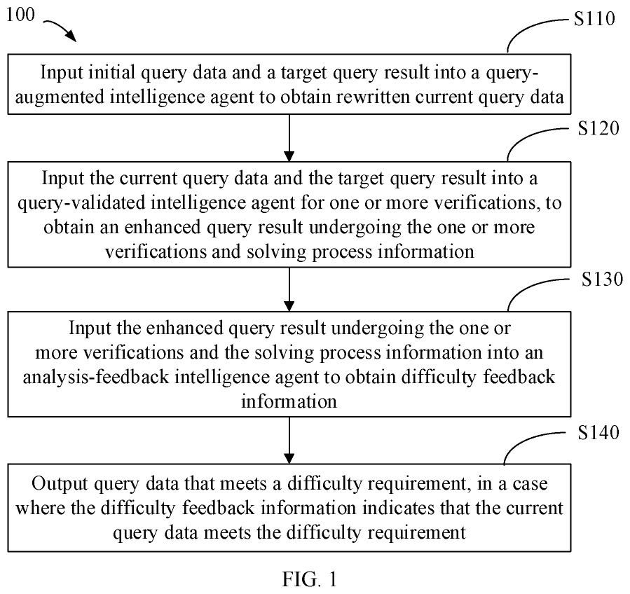

FIG. 1 is a schematic flow diagram of a method 100 of generating query data based on intelligence agents according to an embodiment of the present disclosure. In an implementation, the method may include following steps.

In S110, initial query data and a target query result are input into a query-augmented intelligence agent to obtain rewritten current query data.

In S120, the current query data and the target query result are input into a query-validated intelligence agent for one or more verifications, to obtain an enhanced query result undergoing the one or more verifications and solving process information.

In S130, the enhanced query result undergoing the one or more verifications and the solving process information are input into an analysis-feedback intelligence agent to obtain difficulty feedback information.

In S140, query data that meets a difficulty requirement is output, in a case where the difficulty feedback information indicates that the current query data meets the difficulty requirement.

In the embodiments of the present disclosure, query data may be data including a query request. The query request may also be referred to as a query question, a search request, a query, a question, an enquiry, an inquiry, a retrieval, or the like. The query data may be input into a model, a search engine, a question-answering system, an intelligence agent, a dialogue system or the like to generate a query result. The query data may include data representing a need, an intention, a goal, an emotion or the like. A form of the query data may include a text, an image, a video, an audio or the like, and may also include multimodal data.

In the embodiments of the present disclosure, the query result may also be referred to as an answer, a response, a reply or the like. The model, the search engine, the question-answering system, the intelligence agent, the dialogue system or the like outputs the query result based on the input query data. A form of the query result may include a text, an image, a video, an audio or the like, and may also include multimodal data. A storage form of the query data and the query result may be structured, semi-structured, or unstructured. For example, key-value pairs are used for storage.

In the embodiments of the present disclosure, the initial query data may be extracted from an existing database, historical data or the like. The target query result may include a correct query result based on the initial query data, for example, an initial question and a correct answer. The initial query data and target query result may be from a same source or may be acquired through annotation or other means. For example, if a query question Q1 and its corresponding correct answer A1, a query question Q2 and its corresponding correct answer A2 and the like are extracted from the historical data, then the query question Q1, the query question Q2 and the like are the initial query data, and the answer A1, the answer A2 and the like are the target query result. Alternatively, the initial query data and the target query result may be in a one-to-one or many-to-one form. For example, in the historical data, correct results corresponding to the query question Q1 and the query question Q2 may both be the answer A1.

In the embodiments of the present disclosure, the query-augmented intelligence agent may include a pre-trained intelligence agent capable of reconstructing or rewriting the query data. Taking the initial query data in the form of the text as an example, both the initial query data and the target query result may be input into the query-augmented intelligence agent, which may rewrite the initial query data. A rewriting manner may include various methods: rewriting a single condition into a plurality of conditions that needs to be comprehensively determined through a plurality of pieces of information; blurring overly precise descriptions of time, a position, an entity or the like. The year, the month, and the day in the time may be blurred into a decade, a time range or the like. The position may be blurred by expanding based on an administrative region, a geographical region or the like. A single entity may be deleted or blurred into an entity of a same type. For example, “a major news in xx city in 19xx” may be rewritten as “important information in xx-decade, xx province”, where the xx province may be the province where the xx city is located, or may be changed to the geographical region such as xx flatlands. Through the query-augmented intelligence agent, one piece of the initial query data may be rewritten into one or more pieces of new query data. The new query data is the rewritten current query data.

In the embodiments of the present disclosure, in a case where the query-augmented intelligence agent obtains new query data through rewrite and enhancement, the new query data and the target query result may be sent to the query-validated intelligence agent for performing verification by collaboration of the query-validated intelligence agent. The query-validated intelligence agent may include a pre-trained intelligence agent that may perform a query based on input query data to obtain a query result, and record the solving process information. The query-validated intelligence agent may obtain a new query result based on the new query data, and also may record the solving process information of each query result. The solving process information may include detailed records of various steps experienced during a query process, such as one or more of a semantic understanding process of the query data, an extracting process of a keyword, a queried reference material, an analysis result of the reference material or the like. After inputting the rewritten current query data output by the query-augmented intelligence agent and the target query result into the query-validated intelligence agent, the query-validated intelligence agent may perform one or more queries based on each current query data to obtain one or more new query results and record the solving process information of each of the new query results. The new query result may also be referred to as the enhanced query result. The query-validated intelligence agent may send the enhanced query result and its solving process information to the analysis-feedback intelligence agent for analysis.

In the embodiments of the present disclosure, the analysis-feedback intelligence agent may include a pre-trained intelligence agent that may perform difficulty assessment based on the enhanced query result and the solving process information to obtain the difficulty feedback information. The analysis-feedback intelligence agent may perform the difficulty assessment based on the enhanced query result and the solving process information output by the query-validated intelligence agent, combined with the target query result, to obtain the difficulty feedback information. The analysis-feedback intelligence agent determines difficulty of the new query data based on whether the enhanced query result corresponding to the new query data is consistent with the target query result. For example, if a certain result of a plurality of enhanced query results of the new query data is consistent with the target query result, it indicates that this result passes; if it is not consistent with the target query result, it indicates that this result fails. A higher passing rate of a plurality results may indicate that the difficulty of the new query data is low, otherwise it indicates the difficulty is high. In addition to the passing rate, other dimensions may also be used to assess the difficulty, such as solving path consistency, average number of solving steps, and information dispersion degree. Through the difficulty assessment, it may be determined whether the rewritten current query data meets the difficulty requirement, which may include a difficulty threshold, a measurement indicator of a certain dimension or the like. A difficulty assessment result may include meeting the difficulty requirement or not meeting the difficulty requirement. The difficulty assessment result may be included in the difficulty feedback information. If the difficulty feedback information includes the difficulty assessment result indicating that a certain new query data meets the difficulty requirement, this new query data may be used as an output result. This new query data may be used for system capability optimization, training sample expansion, function verification or the like. Of course, one piece of difficulty feedback information may also include difficulty assessment results of a plurality of pieces of new query data, which may be flexibly selected according to specific needs of an actual application scenario. The difficulty feedback information may also include difficulty quantification values respectively corresponding to each of the plurality of pieces of new query data, and these pieces of query data may be subsequently sorted according to the difficulty quantification values, and required data may be selected according to a required difficulty range.

According to the embodiments of the present disclosure, the initial query data may be and rewritten and enhanced through the query-augmented intelligence agent, the enhanced query result and the solving process information of the enhanced query data are obtained through the query-validated intelligence agent, the query data that meets the difficulty requirement is generated by assessing difficulty of the enhanced query data based on the enhanced query result and the solving process information by the analysis-feedback intelligence agent. In an application scenario, the query data that meets the difficulty requirement and its corresponding query result may be used as a sample set used during model training. By driving an adjustment process of the query data with an actual query result, quantitative assessment and adaptive control of the difficulty of the query data may be achieved, thereby improving stability, consistency, and scalability of query data construction. By rewriting and performing difficulty enhancement on the query data through the query-augmented intelligence agent, the scalability of the query data may be improved; after verification and analysis by the query-validated intelligence agent and the analysis-feedback intelligence agent, the stability of the query data is higher, and consistency with the target query result is also better.

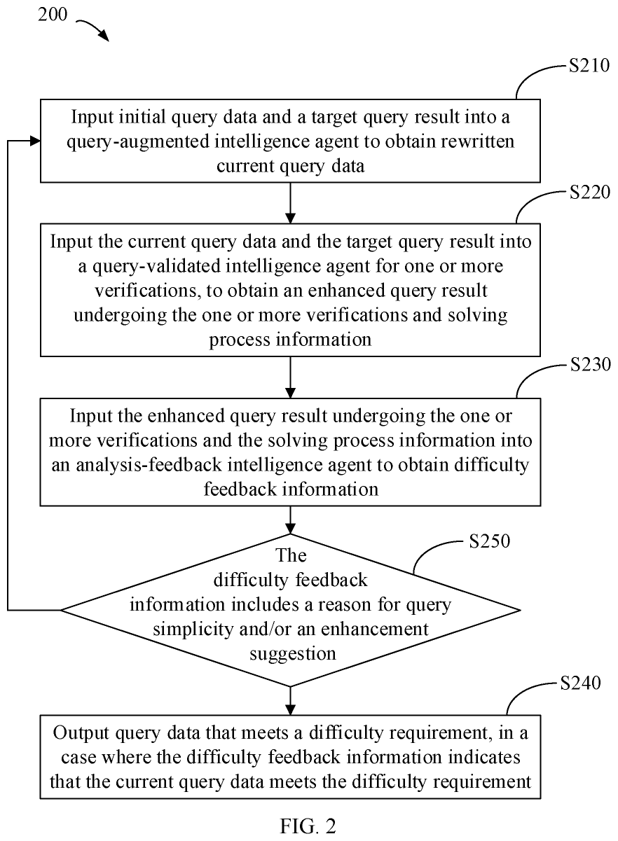

FIG. 2 is a schematic flow diagram of a method of generating query data based on intelligence agents according to another embodiment of the present disclosure. The method may be used to implement one or more features of the aforementioned method of generating query data based on intelligence agents. In an implementation, the method includes S210, S220, S230, and S240, which may be referred to as S110 to S140. Furthermore, the method may further include S250, in which, in a case where the difficulty feedback information includes a reason for query simplicity and/or an enhancement suggestion, the difficulty feedback information is input into the query-augmented intelligence agent, previously current query data is locally rewritten based on the reason for query simplicity and/or the enhancement suggestion to obtain updated current query data, and then the query-validated intelligence agent is circularly called to perform a verification step and the analysis-feedback intelligence agent is circularly called to perform an analysis step based on the updated current query data, until the query data that meets the difficulty requirement is output.

In the embodiments of the present disclosure, if the difficulty assessment result of certain new current query data indicates not meeting the difficulty requirement, the difficulty feedback information may include the difficulty assessment result indicating that the current query data does not meet the difficulty requirement. Furthermore, the reason for query simplicity and/or the enhancement suggestion may further be analyzed based on the solving process information. The difficulty feedback information may include one or more of the reason for query simplicity, the enhancement suggestion or the like. The analysis-feedback intelligence agent may directly feedback the reason for query simplicity to the query-augmented intelligence agent. The query-augmented intelligence agent may execute S210 (or S110) to re-rewrite the initial query data or the current query data based on the reason for query simplicity to obtain new query data. The analysis-feedback intelligence agent may also feedback both the reason for query simplicity and the current query data to the query-augmented intelligence agent, which may re-rewrite the current query data based on the reasons for query simplicity to obtain the new query data. For example, the query-augmented intelligence agent may perform semantic analysis or keyword extraction on the reason for query simplicity to acquire a condition that may guide or constrain a rewriting direction or scope from the reason for query simplicity, and locally rewrite the initial query data or the current query data based on the aforementioned condition to obtain the updated current query data.

In the embodiments of the present disclosure, the analysis-feedback intelligence agent may further analyze the query data based on the reason for query simplicity to obtain the enhancement suggestion. The enhancement suggestion may include a specific suggestion for further rewriting and enhancing the query data, such as replacing a certain description at a specific position in the query data with XX, or blurring a description of time, a position, or an entity at a certain position. The analysis-feedback intelligence agent may feedback the enhancement suggestion to the query-augmented intelligence agent. The query-augmented intelligence agent may re-rewrite the initial query data or the current query data based on the enhancement suggestion to generate the new query data. The analysis-feedback intelligence agent may also feedback both the enhancement suggestion and the current query data to the query-augmented intelligence agent, and the query-augmented intelligence agent may re-rewrite the current query data based on the enhancement suggestion to obtain the new query data. For example, the query-augmented intelligence agent may perform semantic analysis or keyword extraction on the enhancement suggestion to acquire the condition that may guide or constrain the rewriting direction or scope from the enhancement suggestion, and locally rewrite the initial query data or the current query data based on the aforementioned condition to obtain the updated current query data.

In the embodiments of the present disclosure, the updated current query data is input into the query-validated intelligence agent, which may output an updated enhanced query result and solving process information. The updated enhanced query result and the solving process information may be input into the analysis-feedback intelligence agent to obtain the difficulty feedback information. If the analysis-feedback intelligence agent still determines that one or more pieces of current query data do not meet the difficulty requirement after analysis, it may continue to generate a reason for query simplicity and/or an enhancement suggestion, and then return to execute S210, S220, and S230. Furthermore, if it is determined the difficulty requirement is met, S240 is executed, and if it is determined the difficulty requirement is not met, S250 is executed. The above steps S210, S220, S230, and S250 are repeatedly executed until the query data that meets the difficulty requirement is obtained at S240. Of course, the number of iterations may also be set, and in this case, if the query data that meets the difficulty requirement cannot be obtained all the time, execution may also be stopped, and some pieces of query data that are close to meeting the difficulty requirement may be output for subsequent use.

According to the embodiments of the present disclosure, based on the query-augmented intelligence agent, the query-validated intelligence agent, and the analysis-feedback intelligence agent, the query data may be continuously rewritten according to the difficulty of the query data, and the query data that meets the difficulty requirement will be ultimately obtained, which improves generation efficiency and effectiveness of the query data, and enhances consistency of the query data and the query result through collaboration among a plurality of intelligence agents. Furthermore, using query data with enhanced difficulty as a training set of a model is beneficial for improving a query depth of the model.

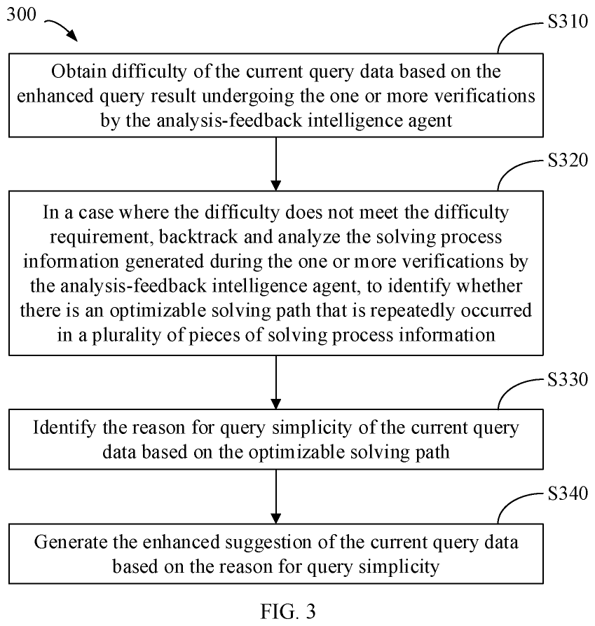

FIG. 3 is a schematic flow diagram of a method of generating query data based on intelligence agents according to another embodiment of the present disclosure. The method may be used to implement one or more features of the aforementioned methods of generating query data based on intelligence agents. In an implementation, the method includes following steps.

In S310, difficulty of the current query data is obtained based on the enhanced query result undergoing the one or more verifications by the analysis-feedback intelligence agent.

In S320, in a case where the difficulty does not meet the difficulty requirement, the solving process information generated during the one or more verifications is backtracked and analyzed by the analysis-feedback intelligence agent, to identify whether there is an optimizable solving path that is repeatedly occurred in a plurality of pieces of solving process information.

In S330, the reason for query simplicity of the current query data is identified based on the optimizable solving path.

In S340, the enhanced suggestion of the current query data is generated based on the reason for query simplicity.

In the embodiments of the present disclosure, the query-validated intelligence agent may perform a plurality of independent solving operations on the enhanced query data. Each solving operation not only outputs the query result but also records complete solving process information. A solving process may also be referred to as a solving trajectory, an answer process, an answer trajectory, or the like. For example, the solving process information may include one or more of a retrieval path, an inference link, an intermediate hit key information fragment, or a solving step sequence in each solving process. If the analysis-feedback intelligence agent determines that the difficulty of the current query data still does not meet the difficulty requirement based on the difficulty assessment result and it needs to proceed to a next round of enhancement, backtracking and analyzing may be performed based on the solving process information generated from the one or more verifications. If it is identified that there is the optimizable solving path that is repeatedly occurred in the plurality of pieces of solving process information, the reason for query simplicity may be further analyzed based on the optimizable solving path, and then the enhancement suggestion is generated based on the reason for query simplicity.

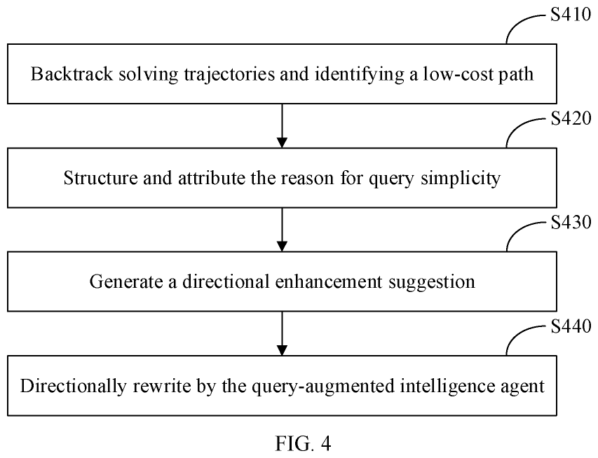

FIG. 4 is an example of a diagnostic analysis process based on the solving trajectory according to an embodiment of the present disclosure.

In S410, backtracking solving trajectories and identifying a low-cost path. The analysis-feedback intelligence agent may backtrack and analyze solving logs and solving trajectories generated by a plurality of independent verifications of the query-validated intelligence agent to identify whether there is a “low-cost solving path” that is repeatedly occurred in a plurality of solving processes. The low-cost solving path is a type of the optimizable solving path. For example, a processing path that requires only a few steps or relies on a single condition in a query to directly locate a target answer belongs to the low-cost solving path. For another example, if 5 times of solving trajectories all show that a system directly hits a paragraph where an answer is located through a precise time definition condition in a query, then the condition is identified as a key element causing insufficient difficulty of the query, and a solving path associated with the condition belongs to the low-cost solving path.

In S420, structuring and attributing the reason for query simplicity. The analysis-feedback intelligence agent generates a structured diagnostic output based on a trajectory analysis result, which may provide a reason why the query is simple. An example of the reason why the query is simple may include following examples: a specific query element identified as an overly strong constraint (referred to as a constraint element) and its position in a query text; a manner and a frequency of the element being utilized by the system in a plurality of solving trajectories; and why the element leads to a too short or overly direct solving path.

In S430, generating a directional enhancement suggestion. The analysis-feedback intelligence agent further generates a targeted enhancement suggestion based on the trajectory analysis result, which specifies a specific adjustment direction. The specific adjustment direction may include: blurring precise time description identified as the overly strong constraint into a time range, rewriting a single-entity definition that leads to a single-step hit into a composite condition requiring cross-entity associative inference, and removing an explicit clue that directly exposes a position of an answer.

In S440, directionally rewriting by the query-augmented intelligence agent. When receiving a next round of enhancement task, an input of the query-augmented intelligence agent not only includes a current query and a correct answer, but also includes aforementioned difficulty assessment feedback (such as the reason for query simplicity and the enhancement suggestion). The augmented intelligence agent performs targeted local rewriting of the query based on the specific element and the adjustment direction indicated in feedback. A rewriting scope focuses primarily on the constraint element indicated by the feedback, while the rest of the query remains unchanged as much as possible to reduce a risk of introducing semantic bias due to significant rewriting. In addition, the query-augmented intelligence agent may also output an enhancement log to record a specific operation of and its basis for rewriting in this round, facilitating traceability and analysis in subsequent rounds.

According to the embodiments of the present disclosure, it is possible to backtrack and analyze query data that still lacks difficulty after enhancement based on the solving process information to obtain a specific reason and an enhancement suggestion, which is beneficial for targeted enhancement in the future, improving effectiveness of the enhanced query data. The targeted enhancement may also reduce the number of times of enhancements, save time and computational power required for the enhancements, and improve efficiency of the enhancements.

In an implementation, the difficulty of the current query data obtained based on the enhanced query result undergoing the one or more verifications by the analysis-feedback intelligence agent is calculated through one or more of the following items:
passing rate, which represents a proportion of times that enhanced query results are consistent with the target query result in a plurality of verifications to a total number of the verifications;
solving path consistency, which represents a degree of consistency between individual solving trajectories obtained by comparing the solving trajectories used by individual solving operations in the plurality of verifications;
average number of solving steps, which represents the number of solving steps taken to reach the target query result in the plurality of verifications; or
information dispersion degree, which represents distribution of key information required to answer the current query data in a knowledge source, which is assessed based on a hit position of the key information recorded in the solving trajectories.

In the embodiments of the present disclosure, the solving process information output by the query-validated intelligence agent may include a solving log and a trajectory of the complete solving process information. The analysis-feedback intelligence agent may extract assessment indicators in a plurality of dimensions based on the process information to comprehensively determine the difficulty of the current query data. For example, the dimensions of the assessment indicators may include a dimension of the passing rate, a dimension of the solving path consistency, a dimension of the average number of solving steps, and a dimension of the information dispersion degree. Based on these assessment indicators, either individually or in combination, a difficulty quantification value may be calculated.

In the embodiments of the present disclosure, the passing rate may represent a proportion of times that output results are consistent with a target answer in a plurality of independent verifications to a total number of the verifications, which reflects a probability that the query data is correctly solved. For example, if 5 times of verifications are performed on certain new current query data, and 3 times of enhanced query results are consistent with the target query result, the passing rate is 0.6 or 60%. The passing rate may be used for basic branch control in closed-loop decision-making, such as giving up and exiting when the passing rate is 0, marking as qualified data and exiting when the passing rate is within a target range (such as [0.2, 0.8]), and triggering the next round of enhancement when the passing rate is (0.8,1].

In the embodiments of the present disclosure, the solving path consistency may represent comparing inference paths or retrieval paths used by the individual solving operations in the plurality of verifications and calculating the degree of consistency between the paths. If the plurality of verifications reaches the target query result or the enhanced query result through highly similar single paths, it indicates that there is a deterministic unique solving path for the query data. Even if the passing rate of the query data has not yet reached 1, actual query difficulty may still be low, and there is a risk of being stably cracked by a specific strategy. If there are significant differences in the solving paths of individual verifications, it indicates that a solving space for the query data is relatively open, and the difficulty assessment needs to be adjusted accordingly.

In the embodiments of the present disclosure, a key operation node set for each solving operation is extracted for K solving trajectories. A similarity between any two paths P_i and P_j is measured by a ratio of sizes of intersection and union of their key operation node sets, the above ratio is calculated for all K(K−1)/2 path pairs and an average of ratios of all K(K−1)/2 path pairs is obtained, to obtain an overall path consistency C. The higher the value of C, the more similar paths are used for a plurality of solving operations, and there may be a single deterministic shortcut for solving a problem, which is actually less difficult. The path consistency may also be quantified as a numerical value. For example, the path P_i has 5 nodes, the path P_j has 3 nodes, and there are 2 same nodes therebetween, the path consistency may be calculated by using a formula. An example formula is: the number of the same nodes÷an average number of nodes, then the path consistency of the above example is 2÷(5+3)=0.5. Of course, another formula may be used without limitation here.

In the embodiments of the present disclosure, the average number of the solving steps may be obtained by counting an average number of inference or retrieval steps taken to reach the target query result or the enhanced query result in the plurality of verifications. The more steps there are, the more layers of information retrieval and inference integration are required for a query data system, which indicates a higher actual processing complexity of the query. For example, if there are 5, 6, 7, 8, and 9 nodes, respective, on each of 5 paths of the 5times of verifications, the average number of the solving steps is (5+6+7+8+9)÷5=7.

In one example, assuming an enhanced query is “among important international physics awards in the past three years, a scientist in quantum experimental field from the R region has won an award for his contributions to particle entanglement, the scientist spent his/her childhood in a town in south of S country, what is the name of the town?”, the target answer is “AR”. After executing one solving operation by the query-validated module, a recorded solving log and a solving trajectory are as follows:

Trajectory Field: Solving Step Sequence

Record contents: step 1: retrieving “important international physics awards in the past three years”→step 2: filtering relevant award records related to the “quantum experiment field” from results→step 3: further limiting the “contributions to particle entanglement” in filtered results→step 4: identifying “R region” scientists from candidates→step 5: retrieving early experiences of candidate scientists and match the condition of the “south of the S country”→step 6: outputting the answer.

Trajectory Field: Retrieval Path

Record contents: the step 1 hits knowledge source documents A, C and D, the step 2 hits the third paragraph of the document A and the second paragraph of the document D, the step 5 hits the first paragraph of a document B and the fourth paragraph of a document E.

Trajectory Field: Intermediate Hit Key Information Fragment

Record content: the step 2 hits the fragment: “the 2022 Nobel Prize in physics recognizes contribution in the field of quantum information science”, the step 3 hits the fragment: “RL verified the quantum entanglement phenomenon through experiments”, the step 5 hit the fragment: “RL was born in 1947 in AR, a town in southwest France, where he/she spent her childhood in early years”.

Trajectory Field: Inference Link

Record contents: “the past three years+international physics awards”→candidate range (Nobel Prize, Wolff prize or the like)→“quantum experiments +particle entanglement”→reduced to RL, CL and other names→“R region”→further reduced→“Southern towns of S country+childhood”→cross validation and confirmation “AR”.

Trajectory Field: Final Answer

Record Contents: AR

The solving log and the solution trajectory undertake two specific functions in subsequent processes:

First, using as a calculation source of multidimensional difficulty assessment.

The analysis-feedback intelligence agent extracts indicators in individual dimensions based on the trajectory information of the plurality of verifications, such as 5 times, calculates the passing rate from the “final answer”. The path consistency is calculated by comparing similarities of the “inference link” of the 5 times of verifications (for example, if 3 times of the 5 times of verifications adopt the same filtering order and the other 2 times adopt different candidate exclusion strategies, the path consistency is at a medium level). The average number of solving steps is counted from the “solving step sequence” (the present example has 6 steps at a time). The information dispersion degree is calculated from distribution of hit documents in the “retrieval path” (the present example involves five document sources, i.e., document A, B, C, D and E, the information dispersion degree is high).

Second, using as an analysis basis of diagnostic feedback.

When the passing rate is 1 (all 5 times are correctly solved) and the next round of enhancement needs to be triggered, the difficulty assessment feedback module backtracks trajectories to locate a specific element that leads to ease of the query. For example, if analysis finds that the inference links of the 5 times of verifications are highly consistent after the step 3, that is, all of them directly lock the only candidate through the fragment of “RL verified the quantum entanglement phenomenon through experiments”, a diagnosis report may point out that the “contributions to particle entanglement” in the query is too directly related to the target person, which constitutes a strong constraint. It is suggested to further indirect this condition (for example, replace it with “contributions to nonlocality verification of microphysical phenomena”) to increase difficulty of filtering candidates in the step 3.

In the embodiments of the present disclosure, the dimension of the information dispersion degree may represent distribution of core information required to answer the query data in the knowledge source, that is assessed based on the hit position of the key information of recorded in the solving trajectories. If required information is concentrated in the same document or paragraph, it is less difficult to obtain the information, and if the required information is dispersed in many different sources and the system needs to integrate the information cross the sources, it is difficult to obtain the information.

In the embodiment of the present disclosure, serial numbers of the knowledge source documents hit in individual solving processes are extracted respective for the solving trajectories of K times of independent verifications, to form a set of hit documents for each verification. The number M{total} of all non-duplicate documents hit in the K times of verifications is counted, and the average number M{avg} of the documents hit in individual verifications. The information dispersion degree is as follows:

H=frac{M{total}}{M{avg}}.

When H=1, it indicates that the documents hit in each verification are totally identical, and the required information is highly centralized. The larger the value of H, the more different sources to which the information required to answer the query is dispersed, and cross-sources integration is required, making it more difficult to obtain the information.

Combined with the calculation process of the previous example:

Taking the enhanced query as an example, the documents hit in each of the 5 times of verifications are: P₁ hits three documents A, B, and D, P₂ hits three documents A, C, and D, P₃ hits three documents A, D, and E, P₄ hits three documents C, D, and F, and P₅ hits three documents A, B, and E. The number of the non-duplicate documents involved in the 5 times of verifications is 6, that is documents A, B, C, D, E and F, that is, M{total}=6. The average number of the documents hit in individual verification is (3+3+3+3+3)/5=3, that is, M{avg}=3. The information dispersion degree H=6/3=2.0.

H=2.0 indicates that the required information is dispersed in six different document sources, and only three of them are required for each solving operation, indicating that information is highly dispersed, and the system needs to cross the sources for retrieval and integration to complete the solving operation.

For comparison, if the query is not enhanced (such as “the birthplace of the French scientist who won the Nobel Prize in physics in 2022”), the 5 times of verifications probably hit the same two documents. At this time, M{total}=2, M{avg}=2, H=1.0, indicating that information is highly centralized and obtaining difficulty is low.

In the embodiments of the disclosure, the aforementioned indicators in the plurality of dimensions may be weighted according to preset weights to obtain a comprehensive difficulty score. The comprehensive score may be used to assist a closed-loop decision-making logic. When the passing rate is near a boundary (for example, the passing rate is 1, but the path consistency is low, and the number of steps is large), the comprehensive difficulty score may provide a more refined basis for judgment, and avoid misjudgment caused by a single indicator of the passing rate. The assessment result in the plurality of dimensions may also directly serve the diagnostic feedback process in the above steps S310-S340. When the path consistency is too high, the diagnosis report may point out that the query has a single solving path that is too determined. When the average number of steps is too small, the diagnosis report may indicate that a reasoning depth required by the query is insufficient. When the information dispersion degree is too low, the diagnosis report may indicate that the information involved in the query is too centralized, and may raise a suggestion to increase a demand for cross-source retrieval.

According to the embodiments of the present disclosure, the difficulty of the current query data may be determined through the plurality of dimensions, more comprehensive and accurate difficulty assessment result may be obtained, more accurate difficulty feedback information may be output, the query data with reasonable difficulty may be obtained, and validity of the query data may be improved.

In an implementation, the reason for query simplicity includes one or more of the constraint element, the position of the constraint element in the current query data, the manner and the frequency of the constraint element being utilized, or a reason why the constraint element leads the generation of the optimizable solving path.

In the embodiments of the present disclosure, the analysis-feedback intelligence agent may first analyze and obtain the solving trajectories according to the complete solving process information, and then extract the reason for query simplicity from the solution trajectories. In the reason for query simplicity, the constraint element may include the specific query element identified as the overly strong constraint, for example, an accurate time (2022), a specific event (xx award) or the like that can directly locate the query result. In the reason for query simplicity, the constraint element may further include the position of the constraint element in the current query data, such as the position of the specific query element in the query text. In the reason for query simplicity, the constraint element may further include the manner and the frequency of the constraint element being utilized, for example, in the solving trajectories, the steps and times of the information such as 2022 and XX award are utilized. The constraint element may further include the reason why the constraint element leads to the generation of the optimizable solving path, for example, there is only one winner of xx award in 2022, so as long as the time and the award are clear, only this winner can be located.

According to the embodiments of the present disclosure, a specific reason and a specific position leading to the reason for query simplicity may be located, thereby providing a basis for targeted rewriting.

In an implementation, the enhancement suggestion includes one or more of:
blurring a description of the constraint element related to the optimizable solving path into a constraint range;
rewriting the single entity definition that leads to the number of hit steps in the optimizable solving path being less than a threshold value into the composite condition requiring cross-entity associative inference; or
removing the explicit clue that directly exposes the target query result.

In the embodiments of the present disclosure, blurring the description of the constraint element into the constraint range may be achieved by lengthening a time range, expanding a single entity to a category to which the entity belongs, and blurring a word element referring to a clear relationship into a word element referring to only an association relationship. For example, 2022 may be blurred into the 21st century, the beginning of the 21st century, the new millennium, or the like. The xx award may be expanded to the field of the xx award, such as drama, literature, physics, chemistry, photography, or the like. The word element “won” referring to a clear owner relationship in “won the xx award” may be modified to a word element such as “make outstanding contributions” or “carry out relevant experiment”, which only indicate the association relationship. For example, the winner of the xx award in 2022 will be rewritten as someone who has made outstanding contributions in the field of xx at the beginning of the 21st century.

In the embodiments of the present disclosure, rewriting the single entity definition is rewritten into the composite condition requiring the cross-entity associative inference may be achieved by replacing the single entity according to its corresponding keyword, describing the single entity laterally rather than directly using the single entity, or the like. For example, a care of a xx brand and a xx model is rewritten into a small household car with a price range of 100000-200000 yuan, the maximum output power of 600W in configuration parameters, engine torque of 400 nm, seat heating and seat ventilation function. The single entity of the car that could be directly determined by the brand and the model has become a car that needs to be filtered first according to a price, configurations, functions and a type.

In the embodiments of the present disclosure, if a certain clue directly exposes the target query result, and the target query result has been mentioned in the query data, the clue may be deleted. For example, if the query data includes relieving cough and reducing phlegm, and the target query result contains granules for relieving cough and reducing phlegm, the granules for relieving cough and reducing phlegm in the query data may be deleted.

According to the embodiments of the present disclosure, a specific modification suggestion may be provided for the query-augmented intelligence agent to carry out targeted secondary rewriting, so as to guide the query-augmented intelligence agent to carry out more targeted local modification, which may improve the efficiency of modification and enhance effectiveness of the modified query data.

In an implementation, locally rewriting the previously current query data based on the reason for query simplicity and/or the enhancement suggestion includes:
blurring a constraint element in the current query data based on a position of the constraint element in the previous query data; and
updating the enhancement log, the enhancement log includes an operation of and/or a basis for rewriting in this round.

In the embodiments of the present disclosure, the query-augmented intelligence agent may directly locate an element that needs to be locally rewritten based on the position of the constraint element in the reason for query simplicity. The query-augmented intelligence agent may perform one or more operations of blurring a constraint range, rewriting the element to be rewritten into the composite condition requiring cross-entity associative inference or deleting the element itself, based on one or more adjustment directions in the enhancement suggestion, to obtain locally targeted rewritten query data.

In the embodiments of the present disclosure, a process of and/or the basis for each time of rewriting may be stored and updated with the enhancement log. The process of rewriting may include what are certain elements rewritten into, what elements are deleted, or the like. The basis for rewriting may include the specific reason for query simplicity and/or enhancement suggestion.

According to the embodiments of the present disclosure, the query data may be accurately rewritten into usable query data, and the process of and the basis for rewriting may be recorded for easy traceability and review.

The method of generating the query data based on the intelligence agents proposed in the embodiments of the present disclosure includes a query data synthesis and difficulty adaptive control method based on collaboration of a plurality of intelligence agents, which is designed and implemented on basis of automated information processing and query generation technology. The method may achieve automatic assessment and progressive enhancement of query problem difficult while ensuring consistency of query semantics and target answers, thus overcoming problems of uncontrollable query problem difficulty, lack of feedback mechanism, and difficulty in continuous optimization in existing technologies.

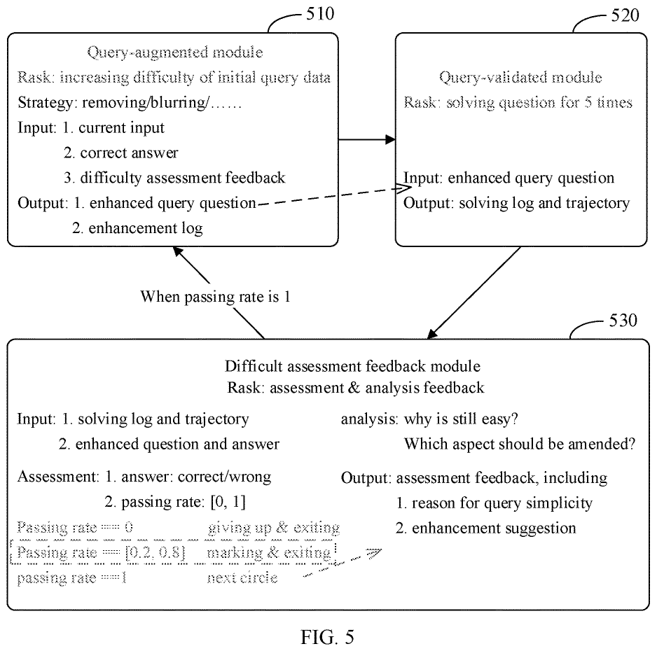

To achieve the above objectives, the embodiments of the present disclosure introduces a closed-loop processing mechanism that combines query enhancement, query validation, and difficulty assessment feedback in the overall design. The mechanism does not rewrite the query for one-time, but rather works collaboratively with the plurality of intelligence agents to gradually approach a preset difficulty range during a plurality of rounds of processing. According to functional division, the technical solution of the embodiments of the present disclosure mainly consists of several processing modules (the plurality of intelligence agents) that cooperate with each other. Overall structure and interaction relationship are shown in FIG. 5.

A query-augmented module 510 is configured to: in a query enhancement stage, the system first receives an original query and its corresponding correct answer, and increases difficulty of a query text by the query-augmented module (the query-augmented intelligence agent). The module takes a premise of keeping the answer unchanged during the processing, and weakens or reorganizes a strong constraint information that can directly locate the answer in the original query, such as rewriting a single condition into a condition that requires comprehensive judgment of a plurality of pieces of information, or blurring overly accurate descriptions of time, position or the like. By using the above manners, the query becomes more complex in both form and semantics, thereby increasing its processing difficulty. Moreover, an enhanced record is stored in a form of the enhancement log. Unlike rewriting schemes based on fixed rules or templates, the module does not rely on static rules, but rather makes targeted adjustments based on subsequent assessment results.

A query-validated module 520 is configured to: after completing the query enhancement, the system inputs the enhanced query into the query-validated module (the query-validated intelligence agent). The module is used to simulate processing of the query in an actual information processing system. By independently executing query solving operations for a plurality of times (e.g., 5 times), a plurality of sets of processing results and corresponding intermediate process information (solution logs and trajectories) are obtained. Through repeated verification, randomness of single processing results may be effectively avoided, providing a more stable basis for subsequent difficulty judgments. The module solves a problem of lack of solvability verification after query generation.

A difficulty assessment feedback module 530 is configured to: after the query verification is completed, the system enters a difficulty assessment and feedback stage. The difficulty assessment feedback module (a difficulty assessment intelligence agent or the analysis-feedback intelligence agent) determines correctness of a plurality of processing results output by the query-validated module, and calculates a stable passing situation of the query based on a proportion of correct results. Based on an assessment result, the system determines whether difficulty of the current query is within an expected range. When the assessment result indicate that the difficulty of the query is insufficient, the difficulty assessment module further analyzes the low-cost processing paths or an overly strong constraint condition present in the query, and generates a corresponding optimization suggestion (assessment feedback, which may include the reason for query simplicity and/or the enhancement suggestion) to be fed back to the query-augmented module 510. When the query difficulty is too high or unsolvable, the difficulty assessment module marks the query as abnormal data and processing is terminated. When the query meets the difficulty requirement, the difficulty assessment module output the query as qualified data.

Through collaborative work of the three modules of query enhancement, query verification, and difficulty assessment feedback mentioned above, the embodiments of the present disclosure construct an automated closed-loop control process that enables continuous optimization of query data in a plurality of rounds of processing. Compared with related technologies, the embodiments of the present disclosure do not rely on manual experience or static rules, but drive a query adjustment process through actual processing results, achieving quantitative assessment and adaptive control of query difficulty, thereby significantly improving stability, consistency, and scalability of query data construction.

The query data synthesis and difficulty adaptive control technology proposed in the embodiments of the present disclosure may effectively improve automation level and overall quality of a query data construction process, thereby bringing significant practical benefits to related information processing products and systems. By introducing a closed-loop control mechanism based on collaboration of the plurality of modules, the technology can continuously generate query data with stable difficulty distribution and high semantic consistency without requiring a large amount of manual participation, significantly reducing labor cost required for manual design and maintenance of query data. By repeatedly verifying and assessing difficulty of query processing results, the generated query data is effectively guaranteed in terms of solvability and stability, avoiding data with low difficulty or unavailability, thereby improving overall data quality. The characteristic helps products maintain stability of query data structure and difficulty level during long-term operation, reducing an impact of data quality fluctuations on system performance. The solution can adaptively adjust difficulty of queries based on an actual processing capacity of the system, making the generated data more in line with a current level of product capabilities and application requirements, thereby improving an actual value of query data in enhancing system capabilities.

In practical applications, the embodiments of the present disclosure help to build a sustainable and evolving query data system, providing long-term and stable data support for products such as intelligent question answering and information retrieval, and enhancing overall intelligence and competitiveness of the products.

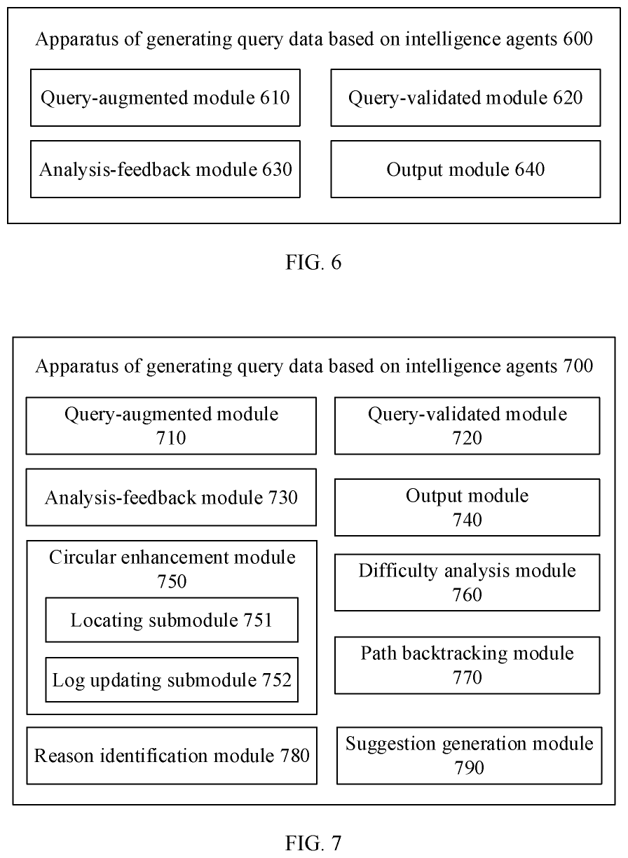

FIG. 6 is a structural diagram of an apparatus 600 of generating query data based on intelligence agents according to an embodiment of the present disclosure. In an implementation, the apparatus may include following modules.

A query-augmented module 610 is configured to input initial query data and a target query result into a query-augmented intelligence agent to obtain rewritten current query data.

A query-validated module 620 is configured to input the current query data and the target query result into a query-validated intelligence agent for one or more verifications, to obtain an enhanced query result undergoing the one or more verifications and solving process information.

An analysis-feedback module 630 is configured to input the enhanced query result undergoing the one or more verifications and the solving process information into an analysis-feedback intelligence agent to obtain difficulty feedback information.

An output module 640 is configured to output query data that meets a difficulty requirement, in a case where the difficulty feedback information indicates that the current query data meets the difficulty requirement.

FIG. 7 is a structural diagram of an apparatus 700 of generating query data based on intelligence agents according to another embodiment of the present disclosure. The apparatus may include a query-augmented module 710, a query-validated module 720, an analysis-feedback module 730 and an output module 740. Functions and descriptions of each module of the apparatus may refer to the description of each module in the above apparatus 600 of generating the query data based on the intelligence agents, which will not be repeated here. In an implementation, the apparatus may further include the following module.

A circular enhancement module 750 is configured to: in a case where the difficulty feedback information includes a reason for query simplicity and/or an enhancement suggestion, input the difficulty feedback information into the query-augmented intelligence agent, locally rewrite previously current query data based on the reason for query simplicity and/or the enhancement suggestion to obtain updated current query data, and then circularly call the query-validated intelligence agent to perform a verification step and circularly call the analysis-feedback intelligence agent to perform an analysis step based on the updated current query data, until the query data that meets the difficulty requirement is output.

In an implementation, as shown in FIG. 7, the apparatus may further include following modules.

A difficulty analysis module 760 is configured to obtain difficulty of the current query data based on the enhanced query result undergoing the one or more verifications by the analysis-feedback intelligence agent.

A path backtracking module 770 is configured to: in a case where the difficulty does not meet the difficulty requirement, backtrack and analyze the solving process information generated during the one or more verifications by the analysis-feedback intelligence agent, to identify whether there is an optimizable solving path that is repeatedly occurred in a plurality of pieces of solving processes information.

A reason identification module 780 is configured to identify the reason for query simplicity of the current query data based on the optimizable solving path.

A suggestion generation module 790 is configured to generate the enhanced suggestion of the current query data based on the reason for query simplicity.

In an implementation, the difficulty of the current query data obtained based on the enhanced query result undergoing the one or more verifications by the analysis-feedback intelligence agent is calculated by one or more of following items:
passing rate representing a proportion of times that enhanced query results are consistent with the target query result in a plurality of verification to a total number of the verification;
solving path consistency representing a degree of consistency between individual solving trajectories used by individual solving operations in the plurality of verifications obtained by comparing the solving trajectories;
average number of solving steps representing a number of solving steps taken to reach the target query result in the plurality of verification; or
information dispersion degree representing distribution of key information required to answer the current query data in a knowledge source, which is assessed based on a hit position of the key information recorded in the solving trajectories.

In an implementation, the reason for query simplicity includes one or more of a constraint element, a position of the constraint element in the current query data, a manner and a frequency of the constraint element being utilized, or a reason why the constraint element leads generation of the optimizable solving path.

In an implementation, the enhancement suggestion includes one or more of: blurring a description of a constraint element related to the optimizable solving path into a constraint range;
rewriting a single entity definition that leads to a number of hit steps in the optimizable solving path being less than a threshold value into a composite condition requiring cross-entity associative inference; or removing an explicit clue that directly exposes the target query result.

In an implementation, as shown in FIG. 7, the circular enhancement module 705 may include following submodules.

A locating submodule 751 is configured to blur a constraint element in the previously current query data based on a position of the constraint element in the previous query data.

A log updating submodule 752 is configured to an enhancement log, the enhancement log includes an operation of and/or a basis for rewriting in this round

Descriptions to specific functions and examples of respective units in the apparatus according to the embodiment of the present disclosure may refer to related descriptions to corresponding steps of the above method embodiments, and will not be repeated here.

In the technical solution of the present disclosure, acquisition, storage and application of a user's personal information involved are all in compliance with provisions of relevant laws and regulations, and do not violate public order and good customs.

According to an embodiment of the present disclosure, the present disclosure further provides an electronic device, a readable storage medium and a computer program product.

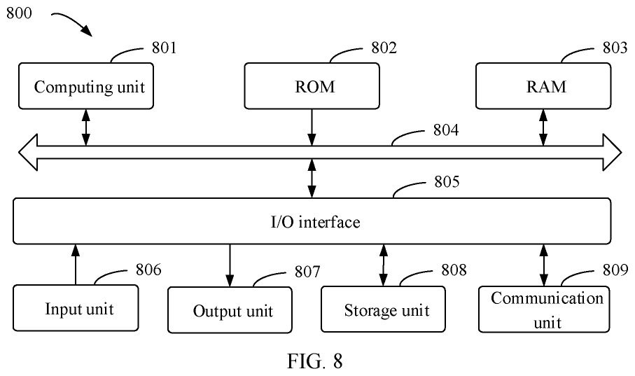

FIG. 8 shows a schematic block diagram of an exemplary electronic device 800 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for operations of the device 800 may also be stored in the RAM 803. The computing unit 801, the ROM 802 and the RAM 803 are connected to each other through a bus 804. An input/output (I/O) interface 805 is also connected to the bus 804.

A plurality of components in the device 800 are connected to the I/O interface 805, and include an input unit 806 such as a keyboard, a mouse, or the like; an output unit 807 such as various types of displays, speakers, or the like; the storage unit 808 such as a magnetic disk, an optical disk, or the like; and a communication unit 809 such as a network card, a modem, a wireless communication transceiver, or the like. The communication unit 809 allows the device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 801 performs various methods and processing described above, such as the method of generating query data based on intelligence agents. For example, in some implementation, the method of generating query data based on intelligence agents may be implemented as a computer software program tangibly contained in a computer-readable medium, such as the storage unit 808. In some implementations, a part or all of the computer program may be loaded and/or installed on the device 800 via the ROM 802 and/or the communication unit 809. When the computer program is loaded into RAM 803 and executed by the computing unit 801, one or more steps of the method of generating query data based on intelligence agents described above may be performed. Alternatively, in other embodiments, the computing unit 801 may be configured to perform the method of generating query data based on intelligence agents by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may include being implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

Program codes for implementing the method of the present disclosure may be written in any combination of one or more programming languages. The program codes may be provided to a processor or controller of a general-purpose computer, a special-purpose computer or other programmable data processing devices, which enables the program codes, when executed by the processor or controller, to cause the functions/operations specified in the flow diagram and/or block diagram to be implemented. The program codes may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to a user; and a keyboard and a pointing device (e.g., a mouse or a trackball) through which the user may provide input to the computer. Other types of apparatuses may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system including a back-end component (which serves as, for example, a data server), or in a computing system including a middleware component (which serves as, for example, an application server), or in a computing system including a front-end component (e.g., a user computer with a graphical user interface or a web browser through which the user may interact with the implementation of the system and technologies described herein), or in a computing system including any combination of the back-end component, the middleware component, or the front-end component. Components of the system may be connected to each other through digital data communication in any form or medium (e.g., a communication network). Examples of the communication network include a Local Area Network (LAN), a Wide Area Network (WAN), and the Internet.

A computer system may include a client and a server. The client and the server are generally far away from each other and usually interact with each other through the communication network. A relationship between the client and the server is generated by computer programs running on corresponding computers and having a client-server relationship with each other. The server may be a cloud server, a distributed system server, or a blockchain server.

It should be understood that, steps may be reordered, added or removed by using various forms of the flows described above. For example, respective steps recorded in the present disclosure may be performed in parallel, in sequence, or in different orders, as long as a desired result of the technical solution disclosed in the present disclosure can be realized, which is not limited herein.

The foregoing specific implementations do not constitute a limitation on the protection scope of the present disclosure. Those having skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method of generating query data based on intelligence agents, comprising:
inputting initial query data and a target query result into a query-augmented intelligence agent to obtain rewritten current query data;
inputting the current query data and the target query result into a query-validated intelligence agent for one or more verifications, to obtain an enhanced query result undergoing the one or more verifications and solving process information;
inputting the enhanced query result undergoing the one or more verifications and the solving process information into an analysis-feedback intelligence agent to obtain difficulty feedback information; and
outputting query data that meets a difficulty requirement, in a case where the difficulty feedback information indicates that the current query data meets the difficulty requirement.

2. The method of claim 1, further comprising:
in a case where the difficulty feedback information comprises a reason for query simplicity and/or an enhancement suggestion, inputting the difficulty feedback information into the query-augmented intelligence agent, locally rewriting previously current query data based on the reason for query simplicity and/or the enhancement suggestion to obtain updated current query data, and then circularly calling the query-validated intelligence agent to perform a verification step and circularly calling the analysis-feedback intelligence agent to perform an analysis step based on the updated current query data, until the query data that meets the difficulty requirement is output.

3. The method of claim 1, further comprising:
obtaining difficulty of the current query data based on the enhanced query result undergoing the one or more verifications by the analysis-feedback intelligence agent;
in a case where the difficulty does not meet the difficulty requirement, backtracking and analyzing the solving process information generated during the one or more verifications by the analysis-feedback intelligence agent, to identify whether there is an optimizable solving path that is repeatedly occurred in a plurality of pieces of solving processes information;
identifying the reason for query simplicity of the current query data based on the optimizable solving path; and
generating the enhanced suggestion of the current query data based on the reason for query simplicity.

4. The method of claim 3, wherein the difficulty of the current query data obtained based on the enhanced query result undergoing the one or more verifications by the analysis-feedback intelligence agent is calculated by one or more of following items:
passing rate representing a proportion of times that enhanced query results are consistent with the target query result in a plurality of verification to a total number of the verification;
solving path consistency representing a degree of consistency between individual solving trajectories used by individual solving operations in the plurality of verifications obtained by comparing the solving trajectories;
average number of solving steps representing a number of solving steps taken to reach the target query result in the plurality of verification; or
information dispersion degree representing distribution of key information required to answer the current query data in a knowledge source, which is assessed based on a hit position of the key information recorded in the solving trajectories.

5. The method of claim 3, wherein the reason for query simplicity comprises one or more of a constraint element, a position of the constraint element in the current query data, a manner and a frequency of the constraint element being utilized, or a reason why the constraint element leads generation of the optimizable solving path.

6. The method of claim 3, wherein the enhancement suggestion comprises one or more of:
blurring a description of a constraint element related to the optimizable solving path into a constraint range;
rewriting a single entity definition that leads to a number of hit steps in the optimizable solving path being less than a threshold value into a composite condition requiring cross-entity associative inference; or
removing an explicit clue that directly exposes the target query result.

7. The method of claim 2, wherein locally rewriting the previously current query data based on the reason for query simplicity and/or the enhancement suggestion to obtain updated current query data comprises:
blurring a constraint element in the previously current query data based on a position of the constraint element in the previous query data; and
updating an enhancement log, the enhancement log comprises an operation of and/or a basis for rewriting in this round.

8. An electronic device, comprising:
at least one processor; and
a memory connected in communication with the at least one processor,
wherein the memory stores an instruction executable by the at least one processor, and the instruction, when executed by the at least one processor, enables the at least one processor to execute:
inputting initial query data and a target query result into a query-augmented intelligence agent to obtain rewritten current query data;
inputting the current query data and the target query result into a query-validated intelligence agent for one or more verifications, to obtain an enhanced query result undergoing the one or more verifications and solving process information;
inputting the enhanced query result undergoing the one or more verifications and the solving process information into an analysis-feedback intelligence agent to obtain difficulty feedback information; and
outputting query data that meets a difficulty requirement, in a case where the difficulty feedback information indicates that the current query data meets the difficulty requirement.

9. The electronic device of claim 8, wherein the instruction, when executed by the at least one processor, enables the at least one processor to further execute:
in a case where the difficulty feedback information comprises a reason for query simplicity and/or an enhancement suggestion, inputting the difficulty feedback information into the query-augmented intelligence agent, locally rewriting previously current query data based on the reason for query simplicity and/or the enhancement suggestion to obtain updated current query data, and then circularly calling the query-validated intelligence agent to perform a verification step and circularly calling the analysis-feedback intelligence agent to perform an analysis step based on the updated current query data, until the query data that meets the difficulty requirement is output.

10. The electronic device of claim 8, wherein the instruction, when executed by the at least one processor, enables the at least one processor to further execute:
obtaining difficulty of the current query data based on the enhanced query result undergoing the one or more verifications by the analysis-feedback intelligence agent;
in a case where the difficulty does not meet the difficulty requirement, backtracking and analyzing the solving process information generated during the one or more verifications by the analysis-feedback intelligence agent, to identify whether there is an optimizable solving path that is repeatedly occurred in a plurality of pieces of solving processes information;
identifying the reason for query simplicity of the current query data based on the optimizable solving path; and
generating the enhanced suggestion of the current query data based on the reason for query simplicity.

11. The electronic device of claim 10, wherein the difficulty of the current query data obtained based on the enhanced query result undergoing the one or more verifications by the analysis-feedback intelligence agent is calculated by one or more of following items:
passing rate representing a proportion of times that enhanced query results are consistent with the target query result in a plurality of verification to a total number of the verification;
solving path consistency representing a degree of consistency between individual solving trajectories used by individual solving operations in the plurality of verifications obtained by comparing the solving trajectories;
average number of solving steps representing a number of solving steps taken to reach the target query result in the plurality of verification; or
information dispersion degree representing distribution of key information required to answer the current query data in a knowledge source, which is assessed based on a hit position of the key information recorded in the solving trajectories.

12. The electronic device of claim 10, wherein the reason for query simplicity comprises one or more of a constraint element, a position of the constraint element in the current query data, a manner and a frequency of the constraint element being utilized, or a reason why the constraint element leads generation of the optimizable solving path.

13. The electronic device of claim 10, wherein the enhancement suggestion comprises one or more of:
blurring a description of a constraint element related to the optimizable solving path into a constraint range;
rewriting a single entity definition that leads to a number of hit steps in the optimizable solving path being less than a threshold value into a composite condition requiring cross-entity associative inference; or
removing an explicit clue that directly exposes the target query result.

14. The electronic device of claim 9, wherein the instruction, when executed by the at least one processor, enables the at least one processor to execute locally rewriting the previously current query data based on the reason for query simplicity and/or the enhancement suggestion to obtain updated current query data, by:
blurring a constraint element in the previously current query data based on a position of the constraint element in the previous query data; and
updating an enhancement log, the enhancement log comprises an operation of and/or a basis for rewriting in this round.

15. A non-transitory computer-readable storage medium storing a computer instruction thereon, wherein the computer instruction is used to cause a computer to execute:
inputting initial query data and a target query result into a query-augmented intelligence agent to obtain rewritten current query data;
inputting the current query data and the target query result into a query-validated intelligence agent for one or more verifications, to obtain an enhanced query result undergoing the one or more verifications and solving process information;
inputting the enhanced query result undergoing the one or more verifications and the solving process information into an analysis-feedback intelligence agent to obtain difficulty feedback information; and
outputting query data that meets a difficulty requirement, in a case where the difficulty feedback information indicates that the current query data meets the difficulty requirement.

16. The non-transitory computer-readable storage medium of claim 15, wherein the computer instruction is used to cause the computer to further execute:
in a case where the difficulty feedback information comprises a reason for query simplicity and/or an enhancement suggestion, inputting the difficulty feedback information into the query-augmented intelligence agent, locally rewriting previously current query data based on the reason for query simplicity and/or the enhancement suggestion to obtain updated current query data, and then circularly calling the query-validated intelligence agent to perform a verification step and circularly calling the analysis-feedback intelligence agent to perform an analysis step based on the updated current query data, until the query data that meets the difficulty requirement is output.

17. The non-transitory computer-readable storage medium of claim 15, wherein the computer instruction is used to cause the computer to further execute:
obtaining difficulty of the current query data based on the enhanced query result undergoing the one or more verifications by the analysis-feedback intelligence agent;
in a case where the difficulty does not meet the difficulty requirement, backtracking and analyzing the solving process information generated during the one or more verifications by the analysis-feedback intelligence agent, to identify whether there is an optimizable solving path that is repeatedly occurred in a plurality of pieces of solving processes information;
identifying the reason for query simplicity of the current query data based on the optimizable solving path; and
generating the enhanced suggestion of the current query data based on the reason for query simplicity.

18. The non-transitory computer-readable storage medium of claim 17, wherein the difficulty of the current query data obtained based on the enhanced query result undergoing the one or more verifications by the analysis-feedback intelligence agent is calculated by one or more of following items:
passing rate representing a proportion of times that enhanced query results are consistent with the target query result in a plurality of verification to a total number of the verification;
solving path consistency representing a degree of consistency between individual solving trajectories used by individual solving operations in the plurality of verifications obtained by comparing the solving trajectories;
average number of solving steps representing a number of solving steps taken to reach the target query result in the plurality of verification; or
information dispersion degree representing distribution of key information required to answer the current query data in a knowledge source, which is assessed based on a hit position of the key information recorded in the solving trajectories.

19. The non-transitory computer-readable storage medium of claim 17, wherein the reason for query simplicity comprises one or more of a constraint element, a position of the constraint element in the current query data, a manner and a frequency of the constraint element being utilized, or a reason why the constraint element leads generation of the optimizable solving path;
wherein the enhancement suggestion comprises one or more of:
blurring a description of a constraint element related to the optimizable solving path into a constraint range;
rewriting a single entity definition that leads to a number of hit steps in the optimizable solving path being less than a threshold value into a composite condition requiring cross-entity associative inference; or
removing an explicit clue that directly exposes the target query result.

20. The non-transitory computer-readable storage medium of claim 16, wherein the computer instruction is used to cause the computer to execute locally rewriting the previously current query data based on the reason for query simplicity and/or the enhancement suggestion to obtain updated current query data, by:
blurring a constraint element in the previously current query data based on a position of the constraint element in the previous query data; and
updating an enhancement log, the enhancement log comprises an operation of and/or a basis for rewriting in this round.
